(19) United States
(12) Patent Application Publication
(10) Pub. No.: US 2013/0149148 A1
(43) Pub. Date: Jun. 13, 2013

(54) CABLE TENSION BRAKE SYSTEM

(71) Applicants: Melvin G. Oster, Newbury Park, CA (US); John Van Ryn, Goleta, CA (US)

(72) Inventors: Melvin G. Oster, Newbury Park, CA (US); John Van Ryn, Goleta, CA (US)

(73) Assignee: Continental Wind Power, Inc., Carpinteria, CA (US)

(21) Appl. No.: 13/370,217

(22) Filed: Feb. 9, 2012

Related U.S. Application Data
(60) Provisional application No. 61/569,121, filed on Dec. 9, 2011.

(51) Int. Cl. F16D 49/08; F03D 7/02

(52) U.S. Cl. 416/9; 188/77 R

(57) ABSTRACT

A wind turbine and braking system. A wind turbine may include a tower and a nacelle coupled to the tower, the nacelle rotatable with respect to the tower about a rotation axis. A collar may be centered on the rotation axis and rigidly connected to one of the nacelle and the tower. A first cable may be wrapped about the collar in a first direction. A first tensioning device may be anchored to a structure of the other of the nacelle and the tower, the first tensioning device configured to selectively apply tension to a first end of the first cable to apply a braking torque to the collar.

### RELATED APPLICATION INFORMATION

This patent claims priority from the following provisional patent applications: Application No. 61/569,121 filed Dec. 9, 2011 entitled Wind Turbine.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to a brake system to control the yaw position of the nacelle of a wind turbine.

2. Description of the Related Art

Wind turbines commonly consist of a tower and a wind-driven rotor coupled to a generator contained within a nacelle mounted on top of the tower. In order to efficiently generate electrical power, the nacelle must be rotated such that the rotor is facing the up-wind direction. Thus wind turbines contain a yaw actuation system to rotate the nacelle as appropriate for the wind conditions. The yaw actuation system must rotate the nacelle at a low rate of speed, and hold the nacelle in a particular yaw orientation when yaw rotation is not desired. In order to reduce wear on motor and other rotating components, the nacelle of the wind turbine is not rotated to follow the wind direction unless there is a fairly gross misalignment.

A yaw system of a wind turbine commonly includes one or more motors and a controller for each of the motors. Each motor typically rotates the nacelle via a high ratio gear box coupled to a pinion and ring gears. Each controller may be configured to control the respective motor and may be coupled to at least one other controller to transmit operation information. A yaw system controller may transmit control information to one or more motor controllers.

High yaw moments can occur both when yaw actuation is in motion and when it is stopped. For example, while the nacelle is being held in a fixed position the wind direction may shift by a significant amount before the nacelle realigns. This shift in the wind direction causes unequal forces on either side of the rotor and tries to rotate the nacelle further out of alignment. Wind-driven yaw moments may be resisted by motor torque, which may require large motors. Alternatively, a yaw braking system may be provided in addition to, or as part of, the yaw actuation system. Conventional brakes, such as caliper brakes, may be provided at the base of the nacelle to prevent undesired rotation of the nacelle with respect to the tower. These brakes are typically large and hydraulically driven.

Several terms used in the subsequent description may be understood with reference to FIG. 1, which shows a cable wrapped about a fixed (non-rotating) capstan 110. for ease of understanding, FIG. 1 shows that cable 120 wrapped about the capstan over a total angel Θ of about 210 degrees. In a practical application, a cable may be wrapped about a capstan for several complete turns. Because of friction between the cable 120 and the surface of the capstan 110, a small holding tension T_{hold} applied to one end of the cable 120 (on the left-hand side of the capstan in this example) may be converted into a much larger load tension T_{load} on the other end of the cable 120 (on the right-hand side of the capstan in this example). Thus a stationary capstan may be used, for example, to allow a smaller mountain climber to belay, or hold the weight, of a heavier climber to prevent falls.

A capstan may be coupled to an engine or motor to cause the capstan to rotate. For example, if the capstan 110 was rotated in the counter-clockwise direction, a small tension T_{hold} on the cable to the left side of the capstan, combined with the friction between the capstan and the cable, would cause a much larger tension T_{load} on the cable on the right side of the capstan. A rotating capstan may be used to allow a person to haul in a cable, for example a mooring line for a ship, that weights far more than the person could haul without mechanical assistance.

The relationship between T_{load} and T_{hold} depends on the total angle the cable is wrapped about the capstan and the coefficient of friction between the cable and the capstan, in accordance with the formula:

T_{load}=T_{hold}e^{μΘ} (1)
wherein:
   T_{load}=maximum tension in the loaded end of the cable before the cable starts to slide with respect to the capstan;
   T_{hold}=tension in the held end of the cable;
   μ=coefficient of friction;
   Θ=total angle the cable is wrapped about the capstan.
      Equation (1), which is commonly called the capstan equation, assumes that the cable is non-elastic and highly flexible. If the cable is not highly flexible, the tension in the loaded end of the cable may be reduced due to the force required to bend the cable around the capstan.

### DESCRIPTION OF THE DRAWINGS

FIG. 1 is a depiction of a capstan.

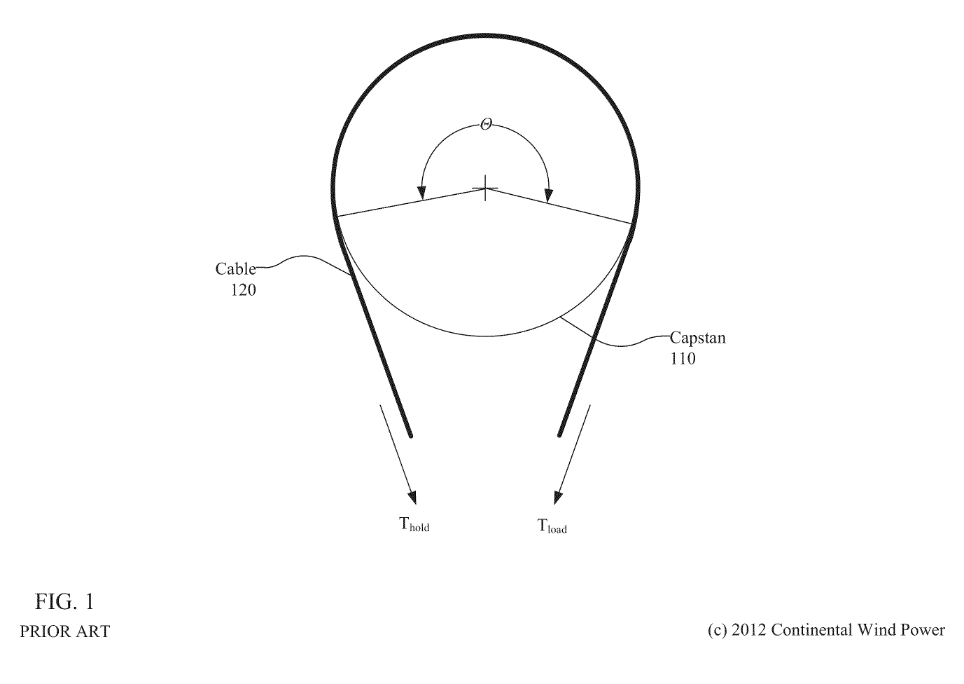

FIG. 2 is a schematic diagram of a cable tension brake system.

FIG. 3 is a schematic diagram of a cable tension brake system for a wind turbine.

FIG. 4 is a schematic side view of the cable tension brake system of FIG. 3.

FIG. 5 is a schematic diagram of another cable tension brake system for a wind turbine.

FIG. 6 is a schematic side view of the cable tension brake system of FIG. 5.

FIG. 7 is a schematic diagram of another cable tension brake system for a wind turbine.

FIG. 8 is a block diagram of a yaw actuator and braking system for a wind turbine.

Throughout this description, elements appearing in figures are assigned three-digit reference designators, where the most significant digit is the figure number where the element is first introduced, and the two least significant digits are specific to the element. An element that is not described in conjunction with a figure may be presumed to have the same characteristics and function as a previously-described element having the same reference designator.

### DETAILED DESCRIPTION

### Description of Apparatus

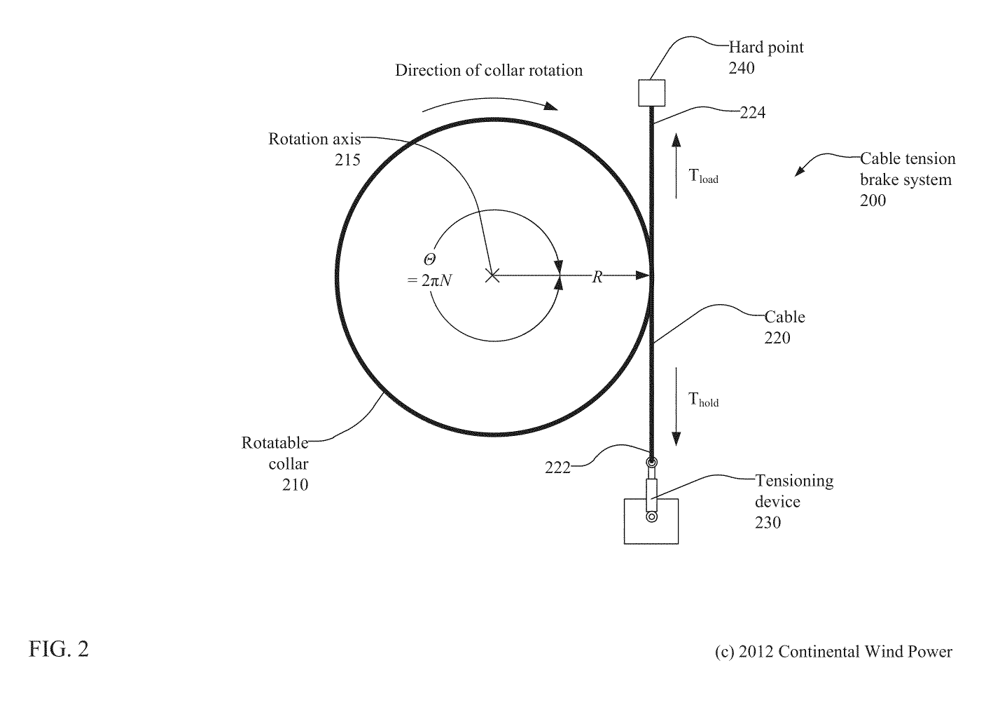

FIG. 2 is a schematic diagram of a cable tension brake system 200 configured to brake a circular collar 210 rotating in a clockwise direction about a rotation axis 215. The cable tension brake system 200 may include a cable 220 having a first end 222 coupled to a tensioning device 230 configured to selectively apply a holding tension T_{hold} to the first end of the cable. A second end 224 of the cable 220 may be attached to a structural element that is immovable with respect to the rotation axis 215. In this patent, a structural element to which a brake cable is anchored will be referred to a “hard point”. A portion of the cable 220 between the first and second ends may be wrapped about the collar 210. In this example, the cable 220 may be wrapped about the collar 210 N times, where N is an integer, such that the total wrap angle Θ may be equal to 2πN.

When the tensioning device 230 applies the holding tension T hold to the first end 222 of the cable 220, the cable 220 will be tightened about the collar 210. The friction between the cable 220 and the collar 210 will result in a load tension T_{load} in the in the second end 224 of the cable 210 attached to the hard point 240. This load tension will tend to brake or oppose the rotation of the collar. Specifically, the load tension will cause a braking torque given by the equation:

B=RT_{hold}e^{μΘ} (2)
wherein:
   B=maximum braking torque applied to the rotating collar;
   T_{hold}=tension in the held end of the cable;
   μ=coefficient of friction between the cable and the collar;
   Θ=total angle the cable is wrapped about the collar;
   R=radius of the collar.
      The expression T_{hold} e^{μΘ} is taken from the right-hand side of the capstan equation (1).

Assuming the cable 220 and the collar 210 are both fabricated from steel, and assuming the collar 210 and the cable 220 are dry (i.e. not lubricated), the coefficient of sliding friction between the cable 220 and the collar 210 may be at least 0.5. In this case, the ratio of T_{load} to T_{hold} (i.e. the value e^{μΘ}) will be greater than 20 if the cable is wrapped a single turn about the collar, greater than 500 if the cable is wrapped 2 turns about the collar, and greater than 12,000 if the cable is wrapped three turns about the collar. Thus a relative modest tensioning device 230 may be used to create a large braking torque.

The braking torque generated by the cable tension brake system 200 will be equal to the torque required to stop rotation of the collar 210, up to the maximum torque B defined in equation (2). If an externally-applied torque on the collar exceeds the maximum braking torque B, the cable tension brake system may not prevent rotation of the collar.

Although the tensioning device 230 is illustrated in FIG. 2 as a hydraulic cylinder, the tensioning device 230 may be any mechanical, hydraulic, pneumatic, electromagnetic, or electromechanical device or combination of devices configured to selectively apply tension to the first end of the cable 220.

Note that the cable tension brake system 200 may be much less effective or ineffective for braking counter-clockwise rotation of the collar 210. In that case, the friction between the cable 220 and the collar 210 would tend to push the second end of the cable towards the hard point 240, which may reduce the effective pressure of the cable 220 against the collar 210 and thus reduce the friction between the cable 220 and the collar 210. In this circumstance, the small friction between the cable and the collar may allow free rotation of the collar.

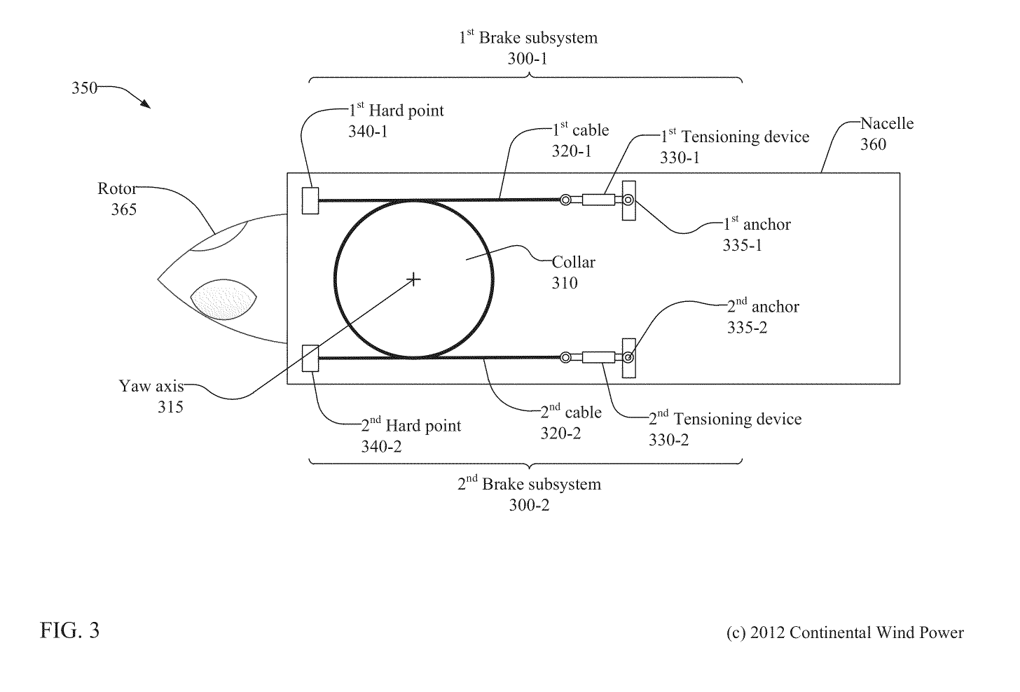

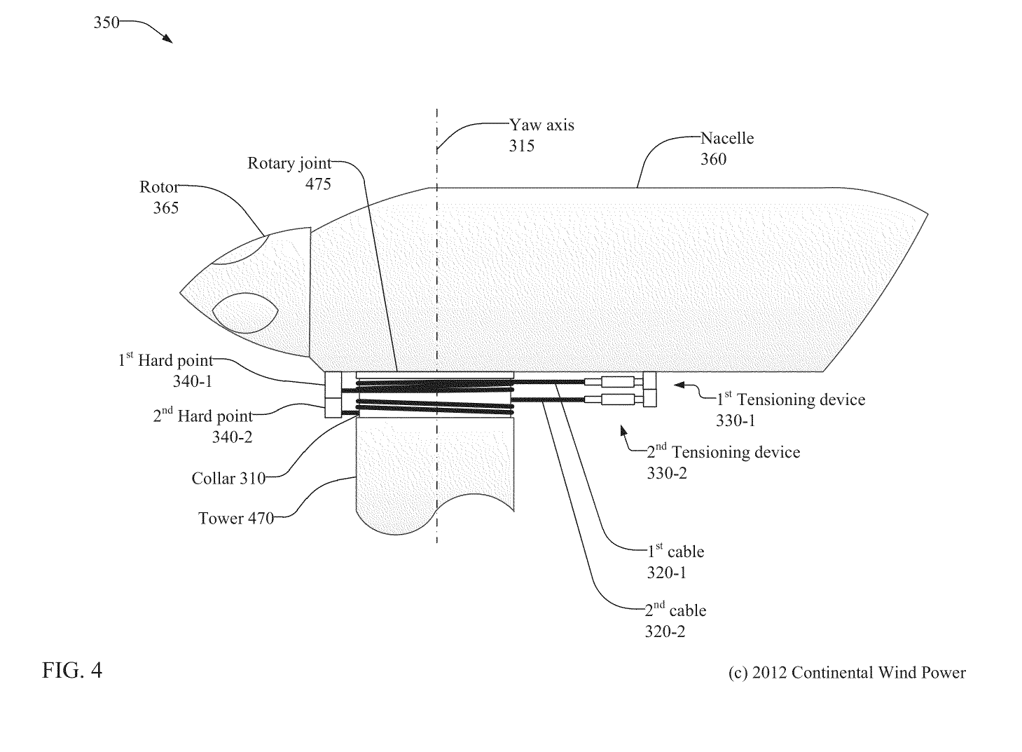

FIG. 3 is a schematic view of a wind turbine 350 from the top along the direction of a yaw axis 315. FIG. 4 is a schematic side view of the wind turbine 350. The wind turbine 350 may include a nacelle 360 coupled to the top of a tower 470 (only shown in FIG. 4) via a rotary joint 475 (only shown in FIG. 4). The rotary joint 475 may include one or more bearings, bushings, or other mechanical components that allow the nacelle to rotate about the yaw axis 315, which may be a vertical axis. The relative position and movement of various parts of the wind turbine 350 will be described based upon these views. For example, the terms “clockwise” and “counter-clockwise” refer to the view of FIG. 3.

The nacelle 360 may enclose a generator system (not shown) coupled to a rotor 365. Three or more blades (not shown) may extend from the rotor 365 such that wind incident upon the blades causes the rotor to rotate, thus driving the generator system to produce electrical power. The wind turbine 350 may include a cable tension brake system to selectively prevent rotation of the nacelle with respect to the tower.

In the examples of FIG. 3 and subsequent figures, a collar (310 in FIG. 3) is attached to the top of the tower and the cable brake system components are attached or included within a nacelle (360 in FIG. 3). Although not shown in any of the figures, an alternate configuration may be used in which the collar is attached to the nacelle and the brake components are attached to the tower. For ease of description, the examples of FIG. 3 and subsequent figures will be described in terms of the collar rotating with respect to the nacelle.

The cable tension brake system may include a first cable 320-1 extending from a first tensioning device 330-1 to a first hard point 340-1. The first tensioning device 330-1 may be anchored to a first anchor 335-1. The first hard point 340-1 and the first anchor 335-1 may be attached to or part of a structure of the nacelle such that the first hard point 340-1 and the first anchor 335-1 may be immovable with respect to each other and with respect to the yaw axis 315. A second cable 320-2 may extend from a second tensioning device 330-2 to a second hard point 340-2. The second hard point 340-2 and the second anchor 335-2 may be attached to or part of a structure of the nacelle 360. Each of the first and second cables 320-1, 320-2 may wrap one or more turns about the collar 310. The first cable 320-1, first tensioning device 330-1 and first hard point 340-1 may form a first brake subsystem 300-1 effective to brake clockwise rotation of the collar 310, as previously described in conjunction with FIG. 2. The second cable 320-2, second tensioning device 330-2 and second hard point 340-2 may form a second brake subsystem 300-2 effective to brake counter-clockwise rotation of the collar 310. The second brake subsystem 300-2 may be a mirror image of the first brake subsystem 300-1 such that the first cable 320-1 and the second cable 320-2 may be wrapped around the collar 310 in opposite directions.

Both the first and second brake subsystems 300-1, 300-2 may be used simultaneously to prevent or inhibit rotation of the collar 310 in either direction. In some circumstances, such as when the nacelle 360 is being rotated to a new position under gusty wind conditions, only one of the first and second brake subsystems 300-1, 300-2 may be engaged to prevent undesired wind-driven rotation in the reverse direction. For example, when the nacelle 350 is being rotated in the clockwise direction, the second brake subsystem 300-2 may be engaged to prevent the wind gusts from forcing the nacelle 360 to rotate in the counter-clockwise direction.

For ease of description, the rotary joint 475 and the various components of the brake subsystems 300-1, 300-2 are visible in FIG. 4 below the nacelle 360. However, in practice, the rotary joint 475 and the components of the brake subsystems 300-1, 300-2 may be fully or partially enclosed within the nacelle 360 and/or the tower 470.

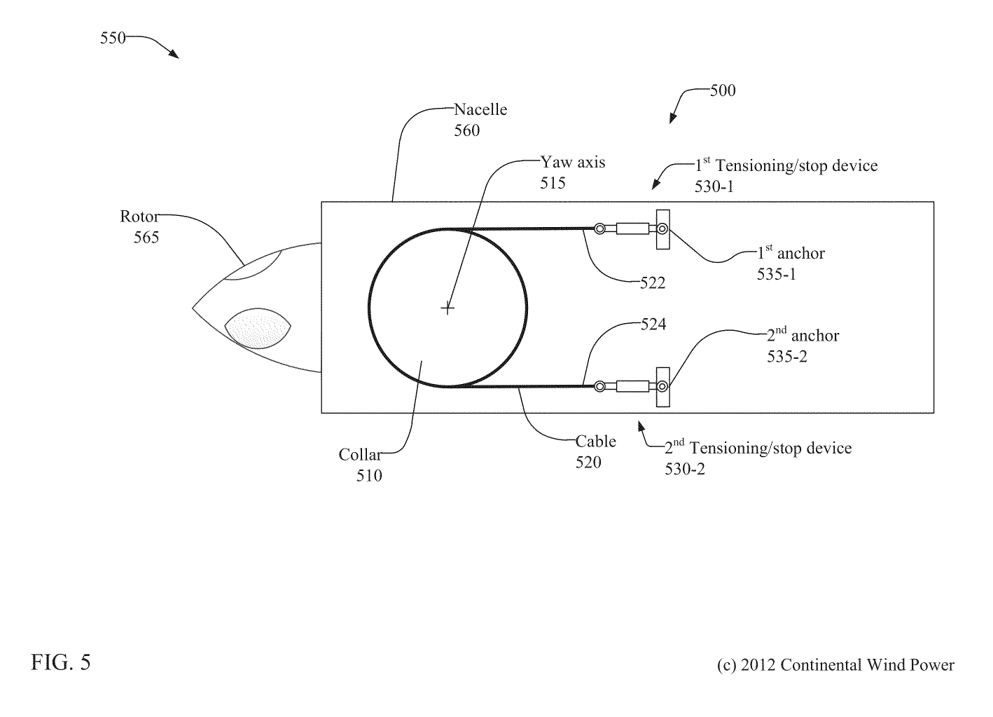

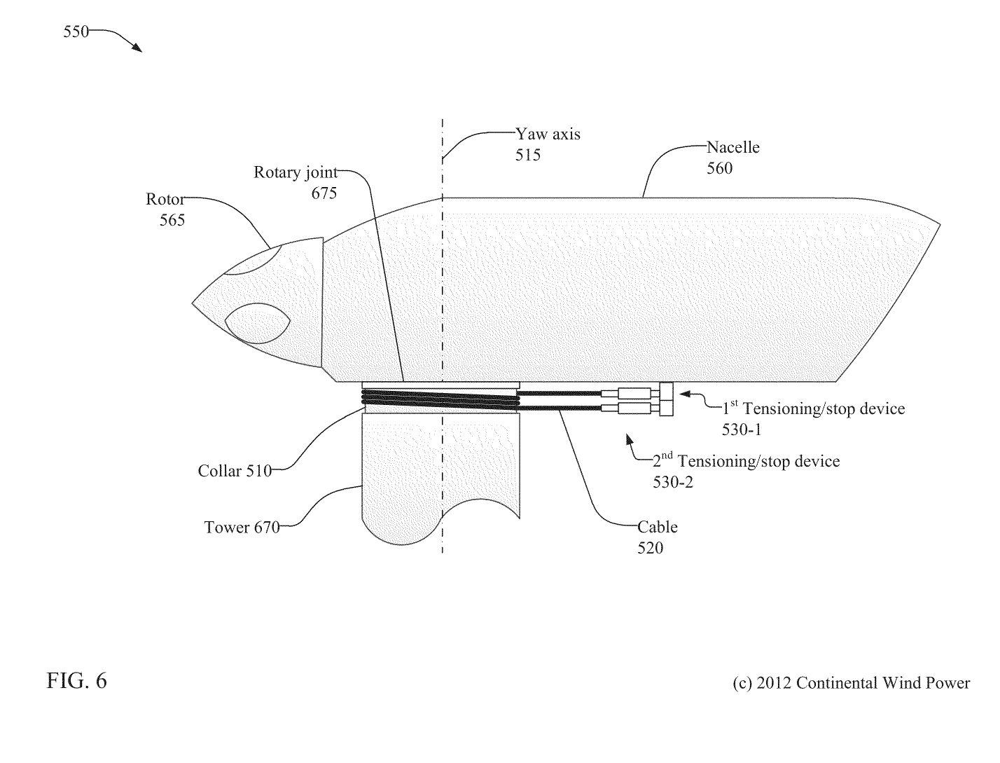

FIG. 5 is a schematic view of another wind turbine 550 from the top along the direction of a yaw axis 515. FIG. 6 is a schematic side view of the wind turbine 550. The wind turbine 550 may include a nacelle 560 coupled to the top of a tower 670 (only shown in FIG. 6) via a rotary joint 675 (only shown in FIG. 6).

The wind turbine 550 may include a cable tension brake system 500 to selectively prevent rotation of the nacelle with respect to the tower. The cable tension brake system 500 may include a single cable 520 wrapped one or more turns about a collar 510. A first end 522 of the cable 520 may be attached to a first tensioning/stop device 530-1. A second end 524 of the cable 520 may be attached to a second tensioning/stop device 530-2. The first tensioning/stop device 530-1 and the second tensioning/stop device 530-2 may be anchored to a first anchor 535-1 and a second anchor 535-2, respectively. The first anchor 535-1 and the second anchor 535-2 may be attached to or part of a structure of the nacelle 560. Each of the first and second tensioning/stop devices 530-1, 530-2 may be configured to selectively apply a holding tension to the respective ends of the cable 520. Each of the first and second tensioning/stop devices 530-1, 530-2 may also serve as a hard stop to prevent movement of the respective end of the cable 520 when tension is applied to the cable from the collar 510, for example by wind-induced torque on the collar 510.

Each of the first and second tensioning/stop devices 530-1, 530-2 may be a single device, such as a robust hydraulic cylinder that has a hard limit to the travel of a piston coupled to the cable 520. Each of the first and second tensioning/stop devices 530-1, 530-2 may be a combination of device such as a mechanical hard stop and a separate mechanical, hydraulic, pneumatic, electromagnetic, or electromechanical device or combination of devices configured to selectively apply tension to the respective ends of the cable 520.

When neither of the first and the second tensioning/stop devices 530-1, 530-2 apply tension to the respective ends of the cable 520, the collar 510 may rotate in either direction without any braking torque. To brake clockwise rotation of the collar 510, tension may be applied to the first end 522 of the cable 520 by the first tensioning/stop device 530-1. Rotation or attempted rotation of the collar 510 in the clockwise direction may then pull the second end 524 of the cable 520 taught against the stop provided by the second tensioning/stop device 530-2, thus generating braking torque on the collar 510 as previously described. Conversely, braking counter-clockwise rotation of the collar 510 may be accomplished by applying tension to the second end 524 of the cable 520. Rotation or attempted rotation of the collar 510 in the counter-clockwise direction may then pull the first end 522 of the cable 520 taught against the stop provided by the first tensioning/stop device 530-1, thus generating braking torque on the collar 510.

To brake the collar 510 against rotation in either direction, tension may be applied to the respective ends of the cable 520 by both the first and second tensioning/stop devices 530-1, 530-2. In this case, rotation or attempted rotation of the collar 520 in either direction may pull the cable 520 taught against either of the first and second tensioning/stop devices 530-1, 530-2, thus generating a braking torque on the collar 510. However, in some circumstances, such as fluctuating gusty winds, the cable 520 may be pulled taught against the first and second tensioning/stop devices 530-1, 530-2 alternatively, which may allow a small degree of alternating rotation of the collar 510.

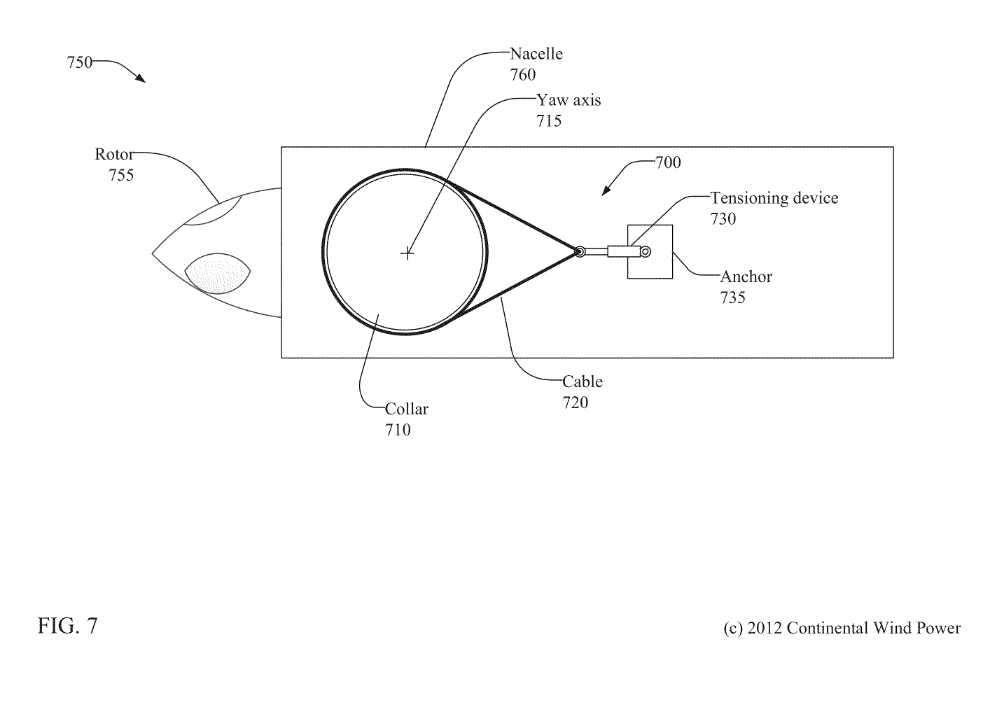

FIG. 7 is a schematic view of another wind turbine 750 from the top along the direction of a yaw axis 715. The wind turbine 750 may include a nacelle 760 coupled to the top of a tower (not shown) via a rotary joint (not shown) such that the nacelle is rotatable with respect to the tower about a yaw avis 715.

The wind turbine 750 may include a cable tension brake system 700 to selectively prevent rotation of the nacelle with respect to the tower. The cable tension brake system 700 may include a single cable 720 wrapped one or more turns about a collar 710. Both ends of the cable 720 may be attached to a tensioning device 730. The tension device 730 may be configured to selectively apply a braking tension to the ends of the cable 720.

When the tensioning device 730 is not applying tension to the ends of the cable 720, the collar 710 may rotate in either direction without any braking torque. To brake rotation of the collar 710 in both the clockwise or counter-clockwise direction, tension may be applied to the ends of the cable 720 by the tensioning device 730. In the cable tension brake system 700, the single tensioning device 730 supplies both the holding tension and the load tension (referring back to FIG. 2). Selective braking one only one direction of rotation is not possible with the cable tension brake system 700.

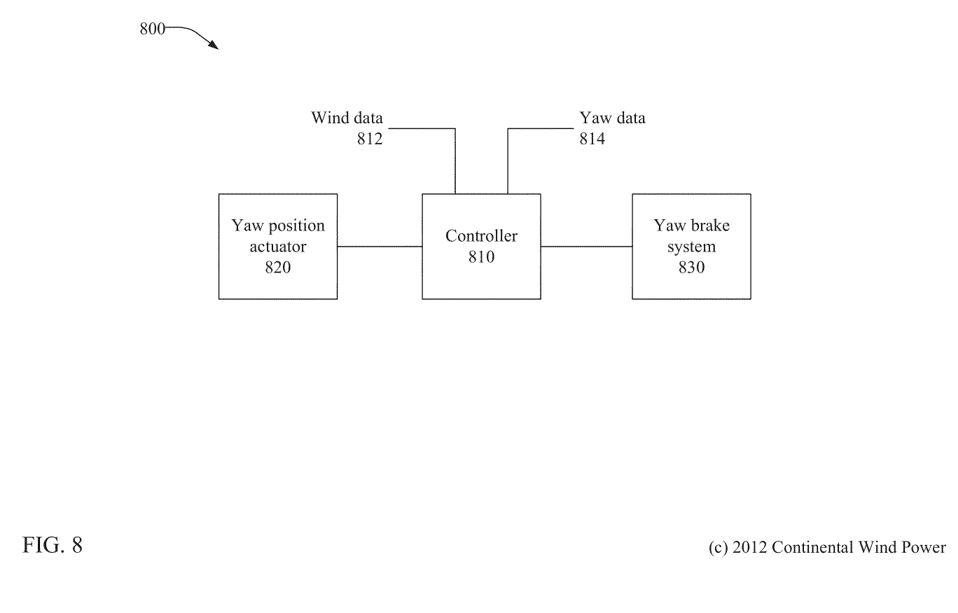

FIG. 8 is a block diagram of a yaw actuator and braking system for a wind turbine. A controller 810 may receive wind data 812 indicating a direction and velocity of incident wind and yaw data 814 indicating a present yaw position of the nacelle of a wind turbine. The wind data 812 and the yaw data 814 may be received from sensors on or coupled to the wind turbine. The controller 810 may determine a desired yaw position for the nacelle of a wind turbine based on the wind data. The controller 810 may then compare the desired yaw position with the current yaw position to determine the necessary rotation of the nacelle. The controller 810 may provide commands to a yaw position actuator 820 to rotate the nacelle to the desired yaw position. The yaw position actuator 820 may include, for example, one or more motors and a gear train to rotate the nacelle. The controller 810 may provide commands to a yaw brake system, which may be a cable tension brake system as shown in FIG. 3 through FIG. 7.

The controller 810 may include hardware and software for providing the functionality and features described herein. The controller 810 may include one or more of: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). The hardware and firmware components of the controller 480 may include various specialized units, circuits, software and interfaces for providing the functionality and features described here. The processes, functionality and features may be embodied in whole or in part in software which operates on one or more processors and may be in the form of firmware, an application program, an applet (e.g., a Java applet), a browser plug-in, a COM object, a dynamic linked library (DLL), a script, one or more subroutines, or an operating system component or service. The hardware and software and their functions may be distributed such that some functions are performed by a processor and others by other devices.

Software instructions for providing some or all of the functionality described herein may be stored on a machine readable storage media in a storage device (not shown) included with or otherwise coupled or attached to the controller 810. These machine readable storage media include, for example, magnetic media such as hard disks, optical media such as compact disks (CD-ROM and CD-RW) and digital versatile disks (DVD and DVD±RW); flash memory cards; and other storage media. As used herein, the term “storage media” does not encompass transitory media such as propagating signals and waveforms. Storage devices include hard disk drives, DVD drives, flash memory devices, and others.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A wind turbine, comprising:
a tower;
a nacelle coupled to the tower, the nacelle rotatable with respect to the tower about a rotation axis;
a collar centered on the rotation axis and rigidly connected to one of the nacelle and the tower;
a first cable wrapped about the collar in a first direction; and
a first tensioning device anchored to a structure of the other of the nacelle and the tower, the first tensioning device configured to selectively apply tension to a first end of the first cable to apply a braking torque to the collar.

2. The wind turbine of claim 1, wherein
a second end of the first cable is attached to a first hard point on the structure of the other of the nacelle and the tower.

3. The wind turbine of claim 2, further comprising:
a second cable wrapped around the collar in a second direction opposed to the first direction; and
a second tensioning device anchored to the structure of the other of the nacelle and the tower, the second tensioning device configured to selectively apply tension to a first end of the second cable to apply a braking torque to the collar, wherein
a second end of the second cable is attached to a second hard point on the structure of the other of the nacelle and the tower.

4. The wind turbine of claim 3, wherein
the collar is attached to the tower,
the first hard point and the second hard point are on the structure of the nacelle, and
the first and second tensioning devices are anchored to the structure of the nacelle.

5. The wind turbine of claim 1, further comprising:
a second tensioning device anchored to the structure of the other of the nacelle and the tower, the second tensioning device configured to selectively apply tension to a second end of the first cable to apply a braking torque to the collar.

6. The wind turbine of claim 1, wherein the first tensioning device is further configured to apply tension to both the first end of the first cable and a second end of the first cable.

7. A braking system, comprising:
a structure;
a circular collar centered on an axis, the collar rotatable with respect to the structure about the axis;
a first cable wrapped about the collar in a first direction; and
a first tensioning device anchored to the structure, the first tensioning device configured to selectively apply tension to a first end of the first cable to apply a braking torque to the collar.

8. The braking system of claim 7, wherein
a second end of the first cable is attached to a first hard point on the structure.

9. The braking system of claim 8, further comprising:
a second cable wrapped around the collar in a second direction opposed to the first direction; and
a second tensioning device anchored to the structure, the second tensioning device configured to selectively apply tension to a first end of the second cable to apply a braking torque to the collar, wherein
a second end of the second cable is attached to a second hard point on the structure.

10. The braking system of claim 7, further comprising:
a second tensioning device anchored to the structure, the second tensioning device configured to selectively apply tension to a second end of the first cable to apply a braking torque to the collar.

11. The braking system of claim 7, wherein the first tensioning device is further configured to apply tension to both the first end of the first cable and a second end of the first cable.
